(19) United States
(12) Patent Application Publication
(10) Pub. No.: US 2020/0304517 A1
(43) Pub. Date: Sep. 24, 2020

(54) System and Method for Authentication of Email Attachments

(71) Applicant: WhitServe LLC, Stamford, CT (US)

(72) Inventor: Wesley W. Whitmyer, Jr., Stamford, CT (US)

(21) Appl. No.: 16/816,450

(22) Filed: Mar. 12, 2020

Related U.S. Application Data
(60) Provisional application No. 62/820,687, filed on Mar. 19, 2019.

(51) Int. Cl. H04L 29/06; H04L 12/58

(52) U.S. Cl. CPC H04L 63/123; H04L 63/0823; H04L 51/12; H04L 63/20; H04L 63/0245

(57) ABSTRACT

A system for authenticating message attachments is disclosed having a computer, a ledger database in data communication with the computer, a message and an attachment received by the computer, software executing on the computer for generating a certificate based on at least one of the message and the attachment, software executing on the computer for recording the certificate on the ledger, software executing on the computer for transmitting the message and the attachment to at least one counterparty.

### TECHNICAL FIELD

The present invention relates to authentication of documents sent as email attachments.

### BACKGROUND

Email provides little protection for spoofing and forging of messages. A message or attachments may be modified or changed before being passed along to a recipient.

Therefore, there exists a need for a system by which a certificate is stored that establishes the authenticity of a message or attachment to anyone looking for verification.

### SUMMARY

An object of the present invention is to provide a system for authenticating emails and their attachments.

It is an object of the invention to provide certificates showing the authenticity of an email or attachment(s).

It is a further object of the invention to allow the certificates to be modifiable or updatable.

In one aspect of the invention, a system for authenticating message attachments is disclosed having a computer, a ledger database in data communication with said computer, a message and an attachment received by said computer, software executing on said computer for generating a certificate based on at least one of the message and the attachment, software executing on said computer for recording the certificate on the ledger, software executing on said computer for transmitting the message and the attachment to at least one counterparty.

The system may further have a document received by said computer, software executing on said computer for generating a second certificate based on the document, software executing on said computer for determining whether the document appears on the ledger, and software executing on said computer for transmitting a response indicative of whether the second certificate appears on the ledger.

The system may further have an adjustment received by said computer, software executing on said computer for correlating the adjustment with a second certificate recorded on said ledger, and software executing on said computer for recording the adjustment on said letter in a manner relating it to the second certificate.

Other embodiments of the system are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is a schematic diagram of the presently disclosed system.

### DETAILED DESCRIPTION

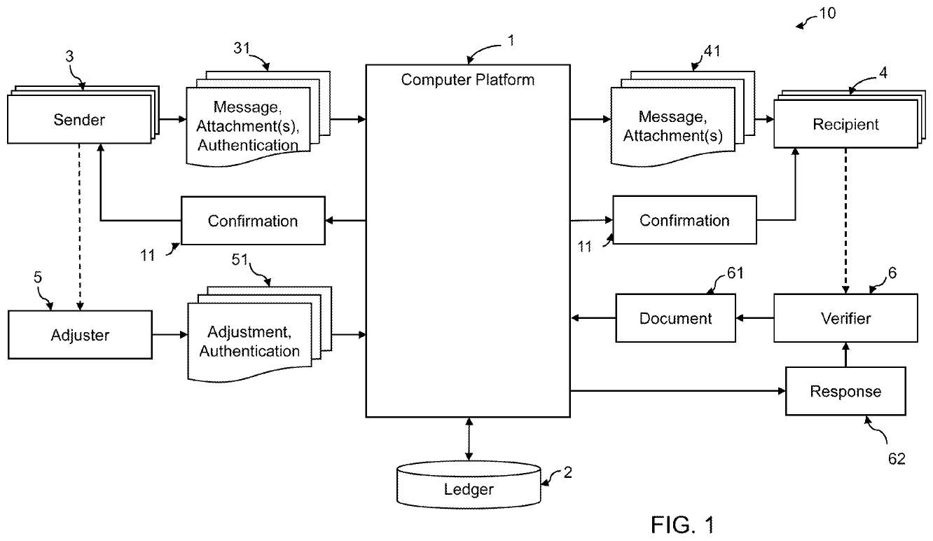

Referring to FIG. 1, the present disclosure describes a system 10 for authenticating email attachments.

The system 10 includes a computer 1. The computer 1 may be a processor, remote computer, computer server, network, or any other typical computing resource. A ledger 2 is in data communication with the computer 1. Ledger 2 may include any immutable sequential database, including a public blockchain, a private blockchain, or a hybrid blockchain.

The computer 1 receives a message 31 from the sender 3. The message 31 may include one or more attachments 31. An authentication 31 may also be provided, including identity of the sender 3, such as a name, a username, or a public key may also be provided, and may also include a password. Sender 3 may use a desktop computer, smartphone, tablet, laptop computer, or other suitable hardware for accessing a remote computing resource to provide the message and attachment(s) to the computer 1. Computer 1 sends the message and any attachment(s) 41 from the sender 3 to the recipient 4.

The computer 1 selects which of the message, attachment(s), and other information (such as a time stamp or sender identification), or a subset thereof, to generate a certificate. The computer may make its selection on a message-by-message basis or based on system or user settings. For example, the computer 1 may be set generate the certificate based on only PDF attachments. Alternatively, the computer 1 may generate the certificate based on PDF attachments if the message contains a certain phrase, such as in the subject line of the message.

The computer 1 may encrypt what will be used to generate the certificate. Alternatively, the computer 1 may have received the message and attachment(s) 31 as encrypted. As an example, the message and/or attachment(s) 31 may be encrypted using the public key of recipient 4. In this case, certificate generated will be unique to the recipient 4, and no one besides recipient 4 will be able to verify the authenticity.

The computer 1 generates a certificate based on its selection. Multiple certificates may be generated. For instance, one certificate may be generated for each message and attachment, or a single certificate may be generated based on the message and all attachments as a whole. The certificate may be generated by a hash function or other one-way function. Known cryptographic methods such as salts and padding may be utilized in generating the certificate and subsequently be stored (on a database accessible to the computer 1 or on the ledger 2) as necessary.

The computer 1 determines whether the certificate was previously recorded in ledger 2. The computer 1 records the certificate on the ledger 2 if no previous record is found. Along with the certificate, an identity of the sender, such as a username or public key may be recorded. A timestamp and/or expiry date may also be recorded. Any other information or notes pertaining to the certificate may also be recorded by the computer 1 on the ledger 2.

If the certificate was previously recorded in ledger, no new record need be added. However, it may be beneficial to record a previously-recorded certificate. For example, if a new sender 3 sent the message and attachment(s) 31, different from the sender that previously recorded the same message and attachment(s), a record would show that both senders can attest to authenticity.

A confirmation 11 of recordation may be provided by the computer 1 to the sender 3 and/or recipient 4. The confirmation 11 may contain the record, including the certificate, a ledger index, a time step for the recording. The confirmation 11 may contain instructions on how to verify the certificate. Recording on the ledger 2 may be done in batches, so confirmations may be provided after the message and attachment(s) 41 are sent to the recipient 4. The confirmations 11 sent to the sender 3 and recipient 4 need not be identical.

After a document has been recorded, an adjuster 5 may alter the recording. To do so, the computer 1 receives an adjustment 51 from the adjuster 5. The adjustment 51 may include a new or edited document to be recorded. The adjustment 51 may also include an extension of an expiry date. The adjustment 51 may also revoke the previously-recorded certificate. The computer 1 generates a second certificate based on the adjustment 51, using the documents and information provided as part of adjustment 51. The computer 1 may record the adjustment 51 following largely the same recording process. In some circumstances, the computer 1 may record the second certificate in a manner relating it to the previously-recorded certificate.

The computer 1 may require that adjuster 5 provide an authentication 51 showing that they are authorized to make the adjustment 51. The authentication 51 may match the authentication 31 provided by the sender 3. Alternatively, the authentication 51 may be different but show that the adjuster 5 has permission to make the adjustment 51. For example, the adjustment 51 may show that the adjuster 5 is from the same organization as the sender 3. In some embodiments, the computer 1 may have permissions regarding adjustment that can be set, for example, by the sender 3

At any time, the computer 1 may receive a document 61 from a verifier 6. The computer then determines whether the document 61 has been recorded on the ledger 2. To do so, the computer generates a second certificate based on the document 61. The computer then generates a response 62 indicative of whether the second certificate was previously recorded on the ledger 2. If the document 61 was previously recorded, information from the record, such as the certificate, sender identity, expiry date or other information including conditions on the validity of the certificate, may be provided by the computer 1 in a response 62 to the verifier 6. The response 62 may indicate whether the certificate has expired or been revoked. If the document 61 was previously recorded multiple times, information about each of the records may be provided, or only the most recent may be provided.

For ease of discussion, the system 10 is described relative to FIG. 1, which shows only a single sender 3, recipient 4, adjuster 5, and verifier 6, etc. However, in practice the system 10 will typically include a plurality of senders, recipients, adjusters, verifiers, etc.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of any patent issued on this application in interpreting the claims appended hereto, Applicant that it does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system for authenticating message attachments, comprising:
a computer;
a ledger database in data communication with said computer;
a message and an attachment received by said computer;
software executing on said computer for generating a certificate based on at least one of the message and the attachment;
software executing on said computer for recording the certificate on the ledger;
software executing on said computer for transmitting the message and the attachment to at least one counterparty.

2. The system of claim 1, further comprising software executing on said computer for transmitting a confirmation that the certificate has been recorded to at least one counterparty.

3. The system of claim 1, further comprising software executing on said computer for transmitting a confirmation that the certificate has not been recorded to at least one counterparty.

4. The system of claim 1, further comprising software executing on said computer for recording an identity of at least one counterparty on the ledger in a manner relating the identity of at least one counterparty to the certificate.

5. The system of claim 4, wherein the identity is determined from the message.

6. The system of claim 1, wherein the certificate is generated based on PDF attachments.

7. The system of claim 1, further comprising software executing on said computer for recording an expiration date on the ledger in a manner relating the expiration date to the certificate.

8. The system of claim 1, further comprising:
a document received by said computer;
software executing on said computer for generating a second certificate based on the document;
software executing on said computer for determining whether the document appears on the ledger; and
software executing on said computer for transmitting a response indicative of whether the second certificate appears on the ledger.

9. The system of claim 8, wherein the document includes the attachment.

10. The system of claim 8, wherein the response indicates that the document appears on the ledger.

11. The system of claim 10, wherein the response indicates an expiration date.

12. The system of claim 11, wherein the expiration data has passed.

13. The system of claim 8, wherein the response indicates that the document does not appear on the ledger.

14. The system of claim 1, further comprising:
an adjustment received by said computer;
software executing on said computer for correlating the adjustment with a second certificate recorded on said ledger; and
software executing on said computer for recording the adjustment on said letter in a manner relating it to the second certificate.

15. The system of claim 14, wherein the adjustment includes a revocation.

16. The system of claim 14, wherein the adjustment includes a renewal.

17. The system of claim 14, wherein the adjustment includes a document.

18. The system of claim 17, wherein the document is an updated version of at least one of the message and the attachment.

19. The system of claim 17, further comprising:
software executing on said computer for generating a third certificate based on said document; and
software executing on said computer for recording the third certificate on said ledger in a manner relating it to said adjustment.

20. The system of claim 14, further comprising software executing on said computer for transmitting a confirmation that the adjustment has been recorded on said ledger to at least one counterparty.
